(19) United States
(12) Patent Application Publication
(10) Pub. No.: US 2006/0282352 A1
(43) Pub. Date: Dec. 14, 2006

(54) Printing device accounting data push systems and methods

(75) Inventor: James Legan, Rochester, NY (US)

Correspondence Address: FREDERICK W. GIBB, III;GIBB INTELLECTUAL PROPERTY LAW FIRM, LLC, 2568-A RIVA ROAD, SUITE 304, ANNAPOLIS, MD, 21401, US

(73) Assignee: Xerox Corporation

(21) Appl. No.: 11/119,652

(22) Filed: May 2, 2005

(51) Int. Cl. G07F 19/00

(52) U.S. Cl. 705/30; 705/34

(57) ABSTRACT

Method and system embodiments push accounting data from a printing device to a database. The method/system first accumulates accounting data (printing volume data) in the printing device and then initiates a process of sending (pushing) the accounting data to a database operated by a first entity over a network. The method/system can then verify that the accounting data was properly received by the accounting database, and report the sending of the accounting data to a first entity responsible for the accounting database or to a second, different entity.

### BACKGROUND

The embodiments herein generally relate to copier/printer accounting systems and more particularly to a method/system that pushes accounting data from a printing device to a database.

One conventional disclosure (U.S. Patent Application 2005/0071739, incorporated herein by reference) describes that, in order to reduce operational costs, businesses outsource copying, printing, scanning, and facsimile services to printing businesses or similar types of establishments. Further, corporations typically share document generating devices or multifunctional peripherals among different departments. Document generating devices or multifunctional peripherals are therefore equipped with accounting features and systems to report different customer or department usage information. Such systems typically use an accounting database and a set of counters as known in the art associated with each account. Any operation performed on the document generating device or multifunctional peripheral, such as copying, printing, or scanning, is charged under a different account increasing the counter associated with the account by one.

In such a system, accounting administrators may obtain reports of usage per account. Currently, the accounting administrator pulls the information directly from the document generating device in order for the customer or department to be billed. Thus, with conventional systems, the accounting administrator must initiate the process of accessing the document generating device on a regular basis to obtain the usage data needed to properly bill the customer or department.

U.S. Patent Application 2005/0071739, an accounting agent collects selected accounting information for a plurality of user accounts via any suitable means. Preferably, the accounting agent collects the accounting information via a set of counters. A controller uses an accounting storage medium to store selected accounting data for a plurality of user accounts. The controller selects the parameters for outputting or reporting usage data.

U.S. Patent Application 2005/0071739 further describes that a document generating device generates image data in its normal course. Then, a determination is made whether to report the usage data to the accounting administrator. The document generating device determines if the predefined time interval as specified by the accounting administrator has passed via any suitable means. If the predefined time interval has passed, the accounting agent collects the usage data in accordance with the parameters selected by the accounting administrator via any suitable means. The accounting agent only collects the usage data as specified by any filters or restrictions specified by the accounting administrator. Later, any account counters selected to reset by the accounting administrator are reset.

Therefore, current job based accounting systems utilized in printing devices only work under a “pull” or polling system where the remote accounting database calls the printing device, retrieves all data from the printing device, and then deletes the data stored within the printing device. This is similar to pushing the data at prescribed intervals akin to what is described in U.S. 2005/0071739 at paragraph 20. However, in such systems, there is no opportunity for the data to the verified. Further, such systems do not provide error handling capabilities or the ability to recover from errors.

### SUMMARY

A method embodiment is presented herein that pushes accounting data from a printing device to a database. The method first accumulates accounting data (printing volume data) in the printing device and then initiates a process of sending (pushing) the accounting data to a database operated by a first entity over a network. The method can then verify that the accounting data was properly received by the accounting database, and report the sending of the accounting data to a first entity responsible for the accounting database or to a second, different entity.

Also, if the accounting data was properly received by the accounting database, the method can delete the accounting data from the memory of the printing device so that the printing device can begin accumulating additional accounting data. On the other hand, if the accounting data was not properly received by the accounting database, the method can create an error report and attempt to resend the accounting data. This error report can also be sent to the first entity or to a different entity.

With this method, the accounting data is pushed periodically (at a frequency determined by an application program interface of the printing device). Also, the application program interface of the printing device can select limited portions of the accounting data to send to the accounting database.

An apparatus embodiment is also presented herein. The apparatus embodiment has at least one printing engine and a counter operatively connected to the printing engine. The counter is adapted to accumulate the accounting data (printing volume data). An input/output device (such as an application program interface (API)) is operatively connected to the counter, and is adapted to initiate the process of sending (pushing) the accounting data to the database over the network. Again, this process of pushing data is done at a frequency determined by the input/output device. A comparator is operatively connected to the input/output device, and is used to verify that the accounting data was properly received by the accounting database.

In addition, a processor can be included in the structure. The processor can incorporate the API and the comparator, or the processor can be a separate item that is operatively connected to the counter, the input/output device, and the comparator. If the accounting data was properly received by the accounting database, the processor deletes the accounting data from counter to allow the counter to begin counting additional accounting data. Alternatively, the processor can create an error report if the accounting data was not properly received by the accounting database and attempt to resend the accounting data. Again, the error report can be sent to the entity responsible for the accounting database and/or can be sent to a different entity. Also, the processor can choose to only select portions of the accounting data to send to the accounting database.

Therefore, the embodiments herein provide a printing device that is configured to push data to an accounting database. By pushing the data to a database, the printing device can validate the data and handle any errors as necessary by logging the errors, resending the data, notifying the administrator, etc. The embodiments herein allow third-party vendors of accounting systems (that are commonly attached or added to printing devices) to quickly identify and resolve any errors relating to data accumulation, data transfer, etc. This significantly reduces the amount of time required to resolve customer issues, will ensure accurate accounting, and if issues are encountered, provide for quicker resolution.

These and other features are described in, or are apparent from, the following detailed description.

### BRIEF DESCRIPTION OF THE DRAWINGS

Various exemplary embodiments of the systems and methods are described in detail below, with reference to the attached drawing figures, in which:

FIG. 1 is a schematic representation of a printing apparatus according to embodiments herein;

FIG. 2 is a schematic representation of a processor according to embodiments herein;

FIG. 3 is a schematic representation of a printing apparatus according to embodiments herein;

FIG. 4 is a schematic representation of the network service module shown in FIG. 3; and

FIG. 5 is a flowchart illustrating method embodiments herein.

### DETAILED DESCRIPTION

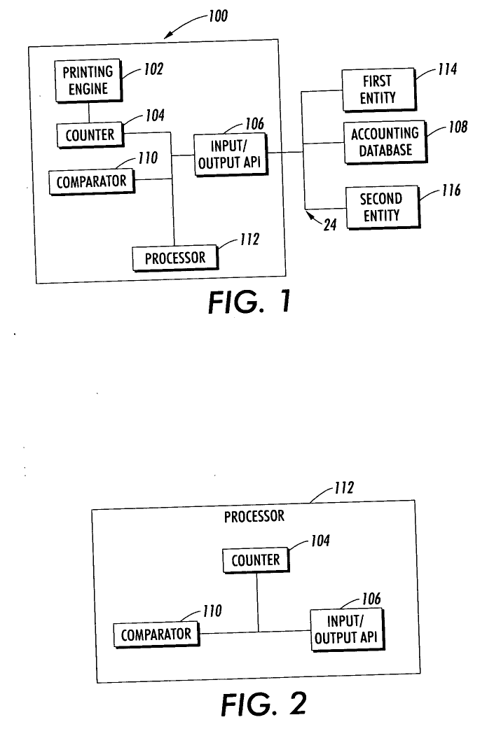

An apparatus embodiment is shown in FIG. 1. The apparatus embodiment 100 has at least one printing engine 102 and a counter 104 operatively connected to the printing engine 102. The printing engine 102 can comprise any form of printing engine including laser, xerographic, inkjet, thermal transfer, etc. and the counter 104 can comprise any type of counter including an electronic counter, mechanical counter, integrated circuit logic counter, etc. The counter 104 includes sufficient memory to accumulate the accounting data and is adapted to accumulate the accounting data (printing volume data).

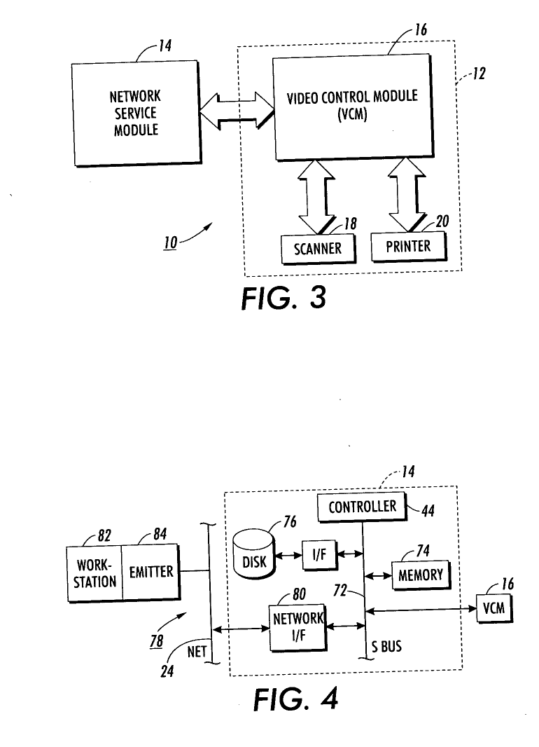

An input/output device 106 (such as an application program interface (API)) is operatively connected to the counter 104, and is adapted to initiate the process of sending (pushing) the accounting data to the database 108 over a network 24. One example of an application program interface is shown in greater detail in FIGS. 3 and 4, discussed below. The API can push data in any commonly supported database format including SQL, Oracle, MySQL, MSDE(SQL), etc.

This process of pushing data is done at a frequency (periodicity) determined by the API input/output device 106. A comparator 110 is operatively connected to the input/output device 106, and is used to verify that the accounting data was properly received by the accounting database 108. By utilizing the “push” based scenario, the printer/copier manufacturer is provided the ability to have control over the accounting data, its handling, error checking, and verification, which traditionally has been the exclusive domain of third-party accounting system vendors. More specifically, with the embodiments herein, the printer/copier manufacturer can be notified of the fact that accounting data has been pushed to an accounting database. Similarly, the printer/copier manufacturer can also be notified of any errors or discrepancies between the accounting data maintained by the printer/copier and the accounting data recorded within the third-party accounting database. This allows the printer/copier manufacturer to verify the results provided by the third-party accounting software vendor. Further, this allows the printer/copier manufacturer to identify, any issues that arise with the accounting abilities of its devices and allows the printer/copier manufacturer to provide additional support and create tools that can troubleshoot for any accounting inaccuracies. From a customer standpoint, this will significantly reduce the amount of time required to resolve accounting related issues and will help ensure accurate accounting and quicker resolution of any errors.

In addition, a processor 112 can be included in the structure. As shown in FIG. 2, the processor 112 can incorporate the counter 104, the API 106 and the comparator 110, or as shown in FIG. 1, the processor 112 can be a separate item that is operatively connected to the counter 104, the input/output device 106, and the comparator 110. If the accounting data was properly received by the accounting database 108, the processor 112 deletes the accounting data from the counter 104 to allow the counter 104 to begin counting additional accounting data from the printing engine 102. Alternatively, the processor 112 can create an error report if the accounting data was not properly received by the accounting database 108 and attempt to resend the accounting data. The error report can be sent to the entity 114 (e.g. third party accounting entity responsible for the accounting database 108 and/or can be sent to a different entity 116 (e.g. printer/copier manufacturer). Also, the processor 112 can choose to only select portions of the accounting data to send to the accounting database 108.

FIG. 3 shows a configuration of a print system in which the apparatus 100 can be used to provide accounting services. A similar system is disclosed in, for example, U.S. Pat. No. 6,535,297, which is incorporated herein by reference. Referring to FIG. 3, a multifunctional, network adaptive printing system is designated by numeral 10. The printing system 10 includes a printing machine 12 operatively coupled to a network service module API 14. The printing machine 12 includes an electronic subsystem 16, referred to as a video control module (VCM), communicating with a scanner 18 and a printer 20. In one example, the VCM 16, that is described in detail in U.S. Pat. No. 5,579,447, the disclosure of which is incorporated herein by reference, coordinates the operation of the scanner and printer in a digital copying arrangement. In a digital copying arrangement, the scanner 18 (also referred to as image input terminal (IIT)) reads an image on an original document by using a CCD full width array and converts analog video signals, as gathered, into digital signals. In turn, an image processing system, associated with the scanner 18, executes signal correction and the like, converts the corrected signals into multi-level signals (e.g., binary signals), compresses the multi-level signals and preferably stores the same in electronic precollation.

Referring still to FIG. 3, the printer 20 (also referred to as image output terminal (IOT)) can comprise, for example, a xerographic print engine. In one example, the print engine has a multi-pitch belt (not shown) which is written on with an imaging source, such as a synchronous source (e.g. laser raster output scanning device) or an asynchronous source (e.g. LED print bar). In a printing context, the multi-level image data is read out of the EPC memory, while the imaging source is turned on and off, in accordance with the image data, forming a latent image on the photoreceptor. In turn, the latent image is developed with, for example, a hybrid jumping development technique and transferred to a print media sheet. Upon fusing the resulting print, it may be inverted for duplexing or simply outputted. It will be appreciated by those skilled in the art that the printer can assume other forms besides a xerographic print engine without altering the concept upon which the disclosed embodiment is based. For example, the printing system 10 could be implemented with a thermal ink jet or ionographic printer.

Referring to FIG. 4, the API 14 is discussed in further detail. In one example, a controller 44 assumes the form of any type of processor and is coupled with a standard SBus 72. In the illustrated embodiment of FIG. 4, a host memory 74, which preferably assumes the form of DRAM, and a SCSI disk drive device 76 are coupled operatively to the SBus 72. While not shown in FIG. 4, a storage or I/O device could be coupled with the SBus with a suitable interface chip. As further shown in FIG. 3, the SBus is coupled with a network by way of an appropriate network interface 80: In one example, the network interface includes all of the hardware and software necessary to relate the hardware/software components of the controller 44 with the hardware/software components of the network 24. As shown, the Network Server module 14 may be interposed between the Video Control Module (VCM) labeled 16 in both FIGS. 3 and 4 and the network 24 itself.

In one example, the network 24 includes a client, such as a workstation 82 with an emitter or driver 84. In operation, a user may generate a job including a plurality of electronic pages and a set of processing instructions. In turn, the job is converted, with the emitter, into a representation written in a page description language, such as PostScript. The job is then transmitted to the controller 44 where it is interpreted with a decomposer. Some of the principles underlying the concept of interpreting a PDL job are provided in U.S. Pat. No. 5,493,634 and U.S. Pat. No. 5,226,112, the disclosures of both references being incorporated herein by reference. As the printer 20 prints the print jobs, the printing volume is accumulated by the counter 104 and is eventually reported to the accounting database 108.

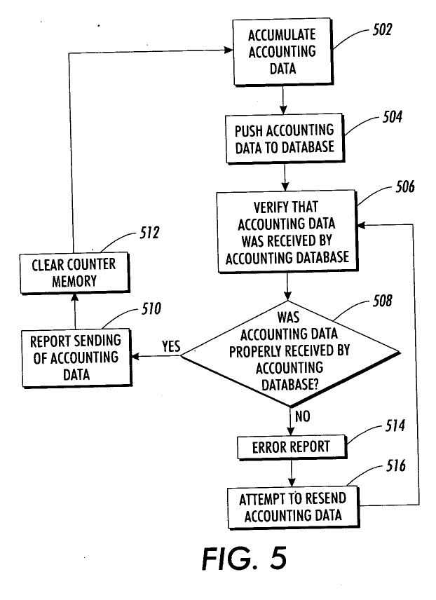

A method embodiment is shown in flowchart form in FIG. 5 that pushes accounting data from a printing device to a database. The method first accumulates accounting data (printing volume data) from the printing engine (item 502) and then initiates a process of sending (pushing) the accounting data to the accounting database (item 504). The method can then verify that the accounting data was properly received by the accounting database (item 506).

If the accounting data was properly received by the accounting database (item 508), the method reports the proper sending of the accounting data (item 510) to a first entity responsible for the accounting database or to a second, different entity. The method can optionally delete the accounting data from the memory of the printing device (item 512) so that the printing device can begin accumulating additional accounting data (process returns to item 502). On the other hand, if the accounting data was not properly received by the accounting database, the method can create an error report (item 514) and attempt to resend the accounting data (item 516). This error report can also be sent to the first entity or to a different entity.

With this method, the accounting data is pushed periodically (at a frequency determined by an application program interface of the printing device). Also, the application program interface of the printing device can select limited portions of the accounting data to send to the accounting database.

Therefore, the embodiments herein provide a printing device that is configured to push data to an accounting database. By pushing the data to a database, the printing device can validate the data and handle any errors as necessary by logging the errors, resending the data, notifying the administrator, etc. The embodiments herein allow third-party vendors of accounting systems (that are commonly attached or added to printing devices) to quickly identify and resolve any errors relating to data accumulation, data transfer, etc. This significantly reduces the amount of time required to resolve customer issues, will ensure accurate accounting, and if issues are encountered, provides for quicker resolution.

It will be appreciated that the above-disclosed and other features and functions, or alternatives thereof, may be desirably combined into many other different systems or applications. Also various presently unforeseen or unanticipated alternatives, modifications, variations or improvements therein may be subsequently made by those skilled in the art which are also intended to be encompassed by the following claims.

What is claimed is:

1. A method comprising:
accumulating accounting data in a printing device;
initiating, by said printing device, a process of sending said accounting data to a database over a network;
verifying that said accounting data was properly received by said accounting database; and
if said accounting data was properly received by said accounting database, deleting said accounting data from memory of said printing device.

2. The method according to claim 1, further comprising creating an error report if said accounting data was not properly received by said accounting database.

3. The method according to claim 2, wherein said error report is sent to a different entity than said accounting database.

4. The method according to claim 1, further comprising resending said accounting data if said accounting data was not properly received by said accounting database.

5. The method according to claim 1, wherein said sending of said accounting data is performed at a frequency determined by an application program interface of said printing device.

6. The method according to claim 1, further comprising selecting limited portions of said accounting data to send to said accounting database as determined by an application program interface of said printing device.

7. The method according to claim 1, wherein said accounting data comprises printing volume data.

8. A method comprising:
accumulating accounting data in a printing device;
initiating, by said printing device, a process of sending said accounting data to a database operated by a first entity over a network;
verifying that said accounting data was properly received by said accounting database;
if said accounting data was properly received by said accounting database, deleting said accounting data from memory of said printing device; and
reporting said sending of said accounting data to a second entity.

9. The method according to claim 8, further comprising creating an error report if said accounting data was not properly received by said accounting database.

10. The method according to claim 9, wherein said error report is sent to a different entity than said first entity.

11. The method according to claim 8, further comprising resending said accounting data if said accounting data was not properly received by said accounting database.

12. The method according to claim 8, wherein said sending of said accounting data is performed at a frequency determined by an application program interface of said printing device.

13. The method according to claim 8, further comprising selecting limited portions of said accounting data to send to said accounting database as determined by an application program interface of said printing device.

14. The method according to claim 8, wherein said accounting data comprises printing volume data.

15. A printing apparatus comprising:
a printing engine;
a counter operatively connected to said printing engine, wherein said counter is adapted to accumulate accounting data comprising printing volume data;
an input/output device operatively connected to said counter, wherein said input/output device is adapted to initiate a process of sending said accounting data to a database over a network;
a comparator operatively connected to said input/output device, wherein said comparator is adapted to verify that said accounting data was properly received by said accounting database; and
a processor operatively connected to said counter, said input/output device, and said comparator, wherein if said accounting data was properly received by said accounting database, said processor is adapted to delete said accounting data from counter.

16. The apparatus according to claim 15, wherein said processor is adapted to create an error report if said accounting data was not properly received by said accounting database.

17. The apparatus according to claim 16, wherein said input/output device is adapted to send said error report to a different entity than said accounting database.

18. The apparatus according to claim 15, further comprising resending said accounting data if said accounting data was not properly received by said accounting database.

19. The apparatus according to claim 15, wherein said sending of said accounting data is performed at a frequency determined by said input/output device.

20. The apparatus according to claim 15, wherein said input/output device is further adapted to select limited portions of said accounting data to send to said accounting database.
